(19) United States
(12) Patent Application Publication
(10) Pub. No.: US 2021/0059113 A1
(43) Pub. Date: Mar. 4, 2021

(54) SYSTEM AND COMPUTER-IMPLEMENTED METHOD FOR CONTROLLING ASH CONTENT IN CUT CROP MATERIAL

(71) Applicant: AGCO Corporation, Duluth, GA (US)

(72) Inventors: Jason Wire, Newton, KS (US); Dean Morrell, Duluth, GA (US); Grant Lewis Good, Moundridge, KS (US)

(73) Assignee: AGCO Corporation, Duluth, GA (US)

(21) Appl. No.: 16/960,795

(22) PCT Filed: Dec. 11, 2018
(86) PCT No.: PCT/IB2018/059859

§ 371 Date: Jul. 8, 2020

Related U.S. Application Data
(60) Provisional application No. 62/615,814, filed on Jan. 10, 2018.

(51) Int. Cl. A01D 34/00; A01D 34/74; A01D 43/10

(52) U.S. Cl. CPC A01D 34/006; A01D 43/10; A01D 34/74

(57) ABSTRACT

A system (42) and computer-implemented method for sensing an amount of ash in cut crop material and automatically adjusting an operating parameter of a mower conditioner to optimize the amount of ash. A sensor (50) measures an measured ash content value of the crop material after it is cut, a processor (48) compares the actual value to a threshold value, and if the actual value exceeds the threshold value, automatically adjusts an operating parameter, such as a height, angle, or speed at which the crop material is cut, a float pressure of the header (12), or a ground speed of the machine (10). Other sensors (64) may measure a roughness of the cut, an excessive stubble height, or other data relevant to optimizing quality, which may also result in adjustments to the operating parameters. The processor (48) may consider an operator-selectable value weighting the measured ash content versus a speed of operation when adjusting the operating parameter.

### FIELD

The present invention relates to systems and methods for cutting crops, and more particularly, embodiments concern a system and computer-implemented method for sensing an amount of ash in cut crop material and responsively adjusting one or more operating parameters of a mower conditioner in order to better control the amount of ash added during a harvesting process.

### BACKGROUND

Producers of certain crops, such as hay, desire to maximize the quality of their crops, particularly with regard to optimizing the amount of ash (i.e., soil, manure residues, and other foreign materials). Ash is primarily a concern in crops that are mowed and windrowed or swathed such as hay, rather than in standing crops such as corn. Both self-propelled and pulled mower conditioners are used to cut these crops. Some part of the total amount of ash is inherent, but another part is added during the harvesting process. Historically, controlling the amount of ash added during the harvesting process has been a manual process of making a subjective qualitative assessment of the amount of ash, and if necessary, manually adjusting an operating parameter in order to reduce the amount of ash. These adjustments have included adjusting a height, tilt, and/or speed of a cutting assembly portion of the mower conditioner.

This background discussion is intended to provide information related to the present invention which is not necessarily prior art.

### SUMMARY

Embodiments address the above-described and other problems by providing a system and computer-implemented method for sensing an amount of ash in cut crop material and responsively adjusting one or more operating parameters of a mower conditioner in order to better control the amount of ash added during a harvesting process, and thereby optimize the quality of the cut crop material.

In a first embodiment of the present invention, a system is provided for controlling an ash content of a crop material cut by a mower conditioner. The mower conditioner may include a crop cutting assembly configured to cut the crop material from a field, and a lift mechanism may be configured to raise and lower the crop cutting assembly. The system may comprise a sensor configured to determine a measured ash content value reflecting an amount of ash in the crop material, and an electronic processing element in communication with the sensor and configured to perform an assessment and adjustment process to control the ash content. The assessment and adjustment process may include receiving the measured ash content value, comparing the measured ash content value to a threshold ash content value, and if the measured ash content value exceeds the threshold ash content value, automatically adjusting an operating parameter of the mower conditioner to optimize the measured ash content value.

In a second embodiment, a mower conditioner is configured to control an ash content of a crop material cut by the mower conditioner. The mower conditioner may comprise a crop cutting assembly, a lift mechanism, one or more sensors, and an electronic processing element. The crop cutting assembly may be configured to cut the crop material from a field. The lift mechanism may be configured to raise and lower the crop cutting assembly. The sensors may be configured to determine a measured ash content value reflecting an amount of ash in the crop material exiting the cutting assembly. The electronic processing element may be in communication with the one or more sensors and configured to at least periodically perform an assessment and adjustment process to control the ash content during operation of the mower conditioner. The assessment and adjustment process may include receiving the measured ash content value, comparing the measured ash content value to a threshold ash content value, and if the measured ash content value exceeds the threshold ash content value, automatically adjusting one or more operating parameters of the mower conditioner to optimize the measured ash content value.

In a third embodiment, a computer-implemented method is provided for improving the functioning of a computer for controlling an ash content in a crop material cut by a mower conditioner. The method may comprise the following steps. A measured ash content value may be sensed reflecting an amount of ash in the crop material. An electronic processing element may perform an assessment and adjustment process to control the ash content at least periodically during operation of the mower conditioner. The assessment and adjustment process may include receiving the measured ash content value, comparing the ash content value to a threshold ash content value, if the ash content value exceeds the threshold ash content value, automatically adjusting an operating parameter of the mower conditioner to optimize the measured ash content value, and communicating the measured ash content value and the operating parameter adjusted by the electronic processing element to a display for viewing by an operator of the mower conditioner.

Various implementations of the foregoing embodiments may include any one or more of the following additional features. The threshold ash content value may be a maximum ash content value. The sensor may be located at an exit of the crop cutting assembly. The operating parameter adjusted by the processing element may include a height and an angle of the crop cutting assembly, which the processing element may adjust by sending a control signal to the lift mechanism. The operating parameter adjusted by the processing element may include a speed of the crop cutting assembly, which the processing element may adjust by sending a control signal to the crop cutting assembly. The operating parameter adjusted by the processing element may include a float pressure of the of the crop cutting assembly, which the processing element may adjust by sending a control signal to the lift mechanism. The operating parameter adjusted by the processing element may include a speed of the mower conditioner, which the processing element may adjust by sending a control signal to a speed controller of the mower conditioner. The assessment and adjustment process may further include communicating the measured ash content value and the operating parameters adjusted by the processing element to a display for viewing by an operator of the mower conditioner. The processing element may be further configured to at least periodically perform the assessment and adjustment process during operation of the mower conditioner. The system may further include one or more additional sensors including a first one or more optical sensors configured to measure a roughness of a cut end of the crop material cut from the field, and a second one or more optical sensors configured to measure a height of a stubble portion of the crop material left in the field.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a perspective view of an exemplary mower conditioner incorporating an embodiment of a system for controlling an amount of ash in crop material cut by the mower conditioner;

FIG. 2 is a fragmentary, cross-sectional, elevation diagrammatical view of a portion of the mower conditioner of FIG. 1 where the system is located; and

FIG. 3 is a flowchart of steps involved in operation of an embodiment of the system for controlling an amount of crop material cut by the mower conditioner.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

Broadly characterized, embodiments provide a system and method for sensing a condition of cut crop material and responsively adjusting a parameter of a mower conditioner to improve the condition. More particularly, embodiments provide a system and computer-implemented method for sensing an amount of ash in cut crop material added during a harvesting process, and responsively adjusting one or more operating parameters of a mower conditioner in order to better control the amount of ash added during the harvesting process, and thereby optimize the quality of the cut crop material.

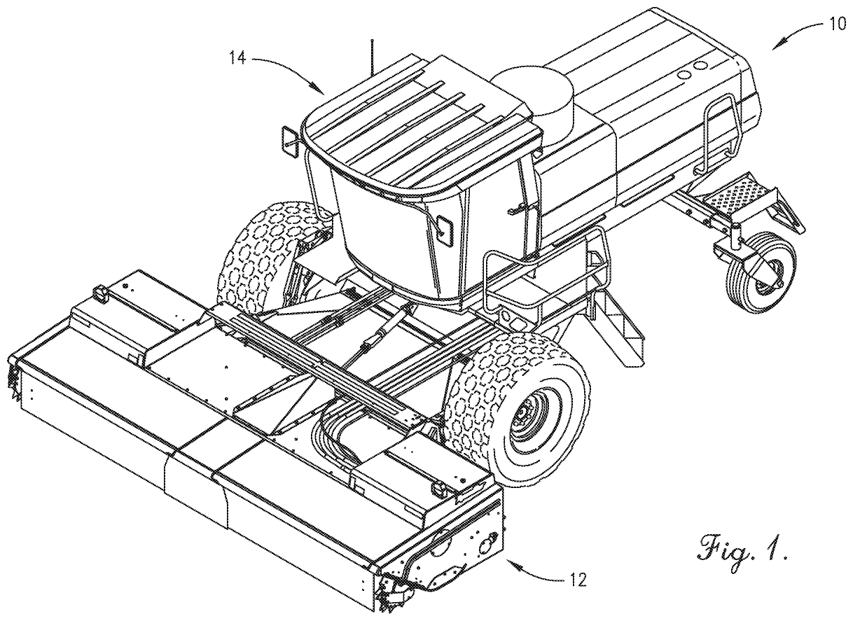

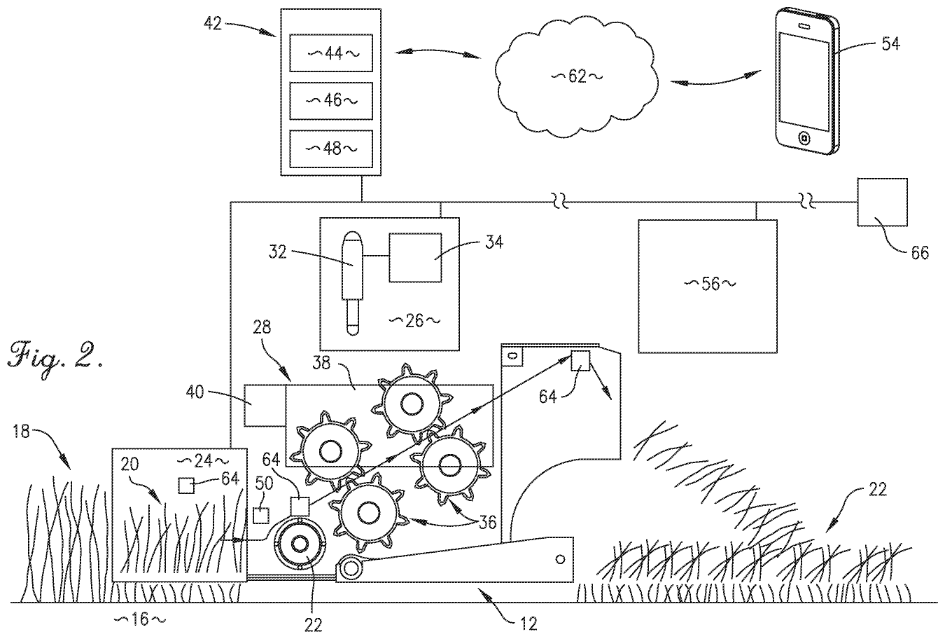

Referring to FIGS. 1 and 2, an exemplary mower conditioner 10 may broadly include a header 12. The mower conditioner 10 may be self-propelled, in which case the header 12 may be coupled to the front of a vehicle having a cab 14, or the mower conditioner 10 may be pulled, in which case the header 12 may be coupled to the rear of a tractor or other towing vehicle (not shown). In both cases, the header 12 may be made to move over a field 16 of standing crop material 18, cut the crop material from the ground, condition the cut crop material 20 as it passes rearwardly through the header 12, and then return the conditioned crop material to the ground in the form of windrows or swathes 22 for drying and subsequent collection.

Referring specifically to FIG. 2, the header 12 may broadly include a crop cutting assembly 24, a lift mechanism 26, and a conditioning mechanism 28. The crop cutting assembly 24 may be configured to cut the crop material from the ground. The crop cutting assembly 24 may employ substantially any suitable crop cutting technology, such as a conventional rotary-type cutter bed or a conventional sickle-type cutter bed. A helper roller 22 may be provided for urging the cut crop material rearward toward the conditioning mechanism 28.

The lift mechanism 26 may be configured to raise, lower, and tilt at least the crop cutting assembly 24 to a desired cutting height and angle during operation, and to raise and lower the entire header 12 to, respectively, a non-operational transport height and an operational height. The lift mechanism 26 may employ substantially any suitable lifting technology, such as a hydraulic mechanism or a mechanical mechanism. In one implementation, the lift mechanism 26 may include at least one lift cylinder 32 and at least one hydraulic lift circuit 34 configured to control the movement of hydraulic fluid to and from the lift cylinder 32 to, respectively, raise and lower the crop-cutting assembly 24 and/or the header 12.

The conditioning mechanism 28 may be configured to receive and condition the cut crop material from the crop cutting assembly 24. The conditioning mechanism 28 may employ substantially any suitable conditioning technology. In one implementation, the conditioning mechanism 28 may include one or more pairs of counter-rotating conditioning rollers 36 configured to condition the crop material, a tensioning mechanism 38 configured to adjustably urge the paired rollers 36 toward one another and resist their separation, and a gap setting mechanism 40 configured to set an adjustable gap between the paired rollers 36.

The conditioning rollers 36 may have relatively non-compressible surfaces made of a hard material, and may take the form of fluted or ribbed steel rollers. Alternatively, the rollers 36 may have relatively compressible surfaces made of rubber or a combination of rubber and steel. Each roller may have a series of radially outwardly projecting ribs that extend along the length of the roller in a helical pattern. The ribs may be spaced around each roller in such a manner that the ribs on one roller intermesh with the ribs of the other paired roller during operation in order to crimp the cut crop material. Alternatively, the rollers may be non-intermeshing in order to crush rather than crimp the cut crop material.

Each pair of conditioning rollers 36 may be mounted in such a way that the one roller is moveable toward and away from the other paired roller, while the position of the latter remains fixed. Alternatively, both rollers may be moveable toward and away from each other. The tensioning mechanism 38 may be configured to adjust a force on one or both of the paired rollers 36 to urge the rollers together to an extent permitted by the gap setting mechanism 40 which sets a running gap between each pair of rollers 36. The tensioning mechanism 38 may employ substantially any suitable technology, such as hydraulic tensioning technology or spring tensioning technology. Different conditions may call for different tension settings on the rollers and/or different gap settings between the rollers.

The mower conditioner 10 may further include an assessment and adjustment system 42 for controlling the amount of ash in the cut crop material. The system 42 may comprise an electronic communications element 44, an electronic memory element 46, an electronic processing element 48, and one or more sensors 50. The communications element 44 may be configured to transmit and receive signal traffic between, e.g., the memory element 46, the processing element 48, and the sensors 50. More broadly, the communications element 44 may facilitate communications between various data sources and various interface devices (e.g., a mobile communications device 54 and/or a fixed display 56 in the cab 14 of the mower conditioner 10 (or in a cab of a corresponding towing vehicle). The communications element 44 may employ substantially any suitable electronic communications technology, such as one or more transceivers (e.g., WWAN, WLAN, and/or WPAN transceivers) functioning in accordance with IEEE standards, 3GPP standards, or other standards, and configured to receive and transmit signals. The communications element 44 may make use of a wired (e.g., a data bus) communication system 60 and/or a wireless (e.g., a network) communications system 62. The wireless communications system 62 may employ substantially any suitable network standard or technology, such as GSM, CDMA, TDMA, WCDMA, LTE, EDGE, OFDM, GPRS, EV-DO, UWB, WiFi, IEEE 802 including Ethernet, WiMAX, and/or others, and may include or support various local area networks (LANs), personal area networks (PAN), or short range communications protocols.

The memory element 46 may be configured to store relevant data for access and use by, e.g., the processing element 48. In particular, the memory element 46 may store a threshold ash value, which may be a maximum ash value. The memory element 46 may employ substantially any suitable electronic memory technology, such as one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The processing element 48 may be configured to receive and analyze data and automatically take action and/or communicate based on the results. In particular, the processing element 48 may be configured to receive data from the sensors 50, analyze the data, and or send control signals to automatically adjust one or more relevant operating parameters of the mower conditioner 10 and/or communicate the results via the display devices 54,56 for consideration by an operator of the mower conditioner 10.

The one or more sensors 50 may be configured to measure the actual amount of ash in the cut crop material 20, and to communicate this data to the memory element 46 and/or the processing element 48 via the communications element 44. In one implementation, the one or more sensors 50 may be located at or proximate to an exit of the cutting assembly 24 and/or an entrance of the conditioning mechanism 28, or otherwise exposed to the cut crop material 20 within the header 12. The sensors 50 may employ substantially any suitable technology for measuring ash content, such as near infrared spectrometer, infrared thermal, or capacitance.

In various implementations, the assessment and adjustment system 42 may further include one or more additional sensors 64 configured to measure or otherwise determine other relevant aspects of the quality of the cut crop material 20, and to communicate this data to the memory element 46 and/or the processing element 48 via the communications element 44. For example, the additional sensors 64 may determine a roughness of the cut, an excessive stubble height, and/or other data relevant to optimizing quality. The location of each additional sensor 64 may depend at least in part on the nature of the aspect of the cut crop material 20 being measured or otherwise determined by the sensor 64. Similarly, each additional sensor 64 may employ substantially any suitable technology for measuring or otherwise determining the aspect, such as near infrared spectrometer, infrared thermal, capacitance, or optical sensors. The data from the additional sensors 64 may be analyzed and used in a manner similar or identical to the data from the ash sensors 50. More specifically, the actual values provided by the additional sensors 64 may be compared to threshold values, and as necessary or desired, one or more operating parameters may be adjusted to optimize the actual values.

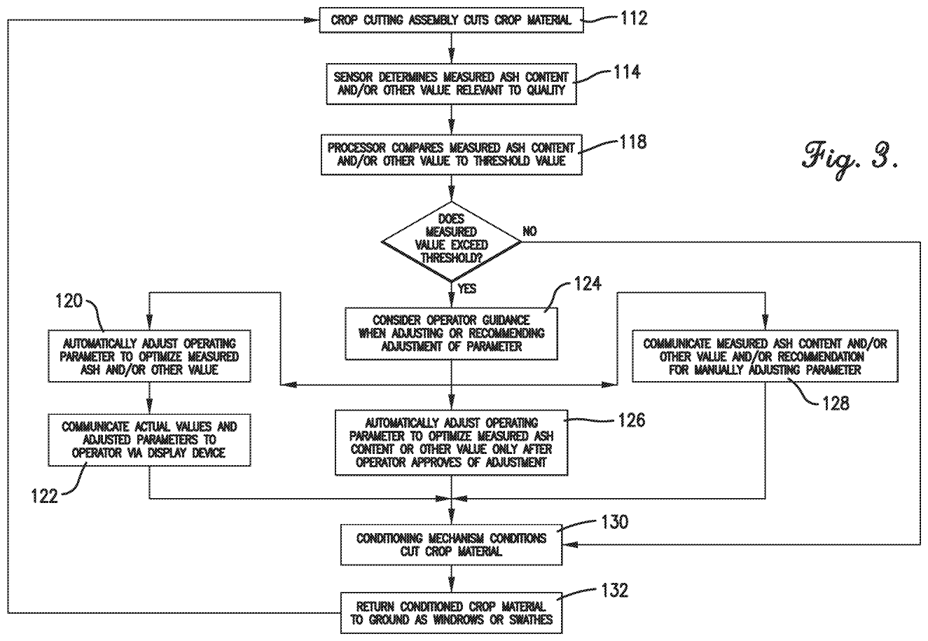

Referring also to FIG. 3, in operation, as the header 12 is made to move over the field 16 of standing crop material 18, the crop cutting assembly 24 may cut the crop material from the ground, as shown in 112, and the one or more sensors 50 may determine a measured ash content value reflecting an actual amount of ash in the cut crop material 20, and/or the additional sensors 64 may determine actual values for other relevant aspects of the quality of the cut crop material, as shown in 114. In general, it may be preferable to determine the measured ash content value at or near the exit of the crop cutting assembly 24.

The processing element 48 may receive the one or more measured ash content and/or other values via the communications element 44, compare the measured ash content and/or other values to a threshold ash content and/or other value stored in the memory element 46, as shown in 118, and if the measured ash content and/or other values exceeds the threshold ash content and/or other value, automatically transmit one or more control signals to adjust at least one of one or more operating parameters of the mower conditioner 10, as shown in 120, to optimize the measured ash content and/or other values of the cut crop material 20, and thereby optimize its quality.

The adjustable operating parameters may include a height and/or angle at which the crop material 18 is cut, which may be controlled by sending a control signal to the lift mechanism 26; a speed at which the crop material 18 is cut, which may be controlled by sending a control signal to the cutting assembly 24; and/or a ground speed of the mower conditioner 10, which may be controlled by sending a signal to a speed controller 66. Additionally, the processing element 48 may communicate the measured ash content and/or other values and/or the one or more operational parameter adjustments to an operator of the mower conditioner 10 via the display device 54,56, as shown in 122.

In one implementation, an operator-selectable weight value which weights quality versus speed may be added to accommodate the desires or needs of particular operators. For example, one operator may wish to optimize quality with less regard to speed, while another operator may wish to maximize speed with less regard to quality. Each such operator may enter their preferred operator-selectable weight value into the memory element 46 for consideration by the processing element 48 when adjusting (or recommending adjustment of) the one or more operating parameters of the mower conditioner 10, as shown in 124.

In one implementation, the processing element 48 may not automatically adjust the one or more operating parameters until approved by the operator, as shown in 126. In another implementation, the processing element 48 may only communicate the measured ash and/or other values and/or a recommendation to adjust the one or more operating parameters, and the operator may then manually adjust the operating parameters, as shown in 128.

Whether adjustments are made or not, the cut crop material 20 may be conditioned by the conditioning mechanism 26 as it passes rearwardly through the header 12, as shown in 130, and then returned to the ground in the form of windrows or swathes 22, as shown in 132, for drying and subsequent collection.

This process of assessment and adjustment may be repeated periodically (e.g., at intervals of between one (1) minute and five (5) minutes, or less than one (1) minute) or continuously during operation of the mower conditioner 10 in order to achieve and maintain the desired condition of the cut crop material.

Thus, it will be appreciated that embodiments of the present invention provide several advantages over the prior art, including making an objective (rather than a subjective) qualitative assessment of the amount of ash; if necessary, automatically (rather than manually) adjusting the relevant parameters of the mower conditioner in order to optimize the amount of ash; and periodically or continuously repeating this process of assessment and adjustment.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system for controlling an ash content of a crop material cut by a mower conditioner, the mower conditioner including—
a crop cutting assembly configured to cut the crop material from a field, and
a lift mechanism configured to raise and lower the crop cutting assembly, and
the system comprising:
a sensor configured to determine a measured ash content value reflecting an amount of ash in the crop material;
an electronic processing element in communication with the sensor and configured to perform an assessment and adjustment process to control the ash content including—
receiving the measured ash content value,
comparing the measured ash content value to a threshold ash content value, and
if the measured ash content value exceeds the threshold ash content value, automatically adjusting an operating parameter of the mower conditioner to optimize the measured ash content value.

2. The system of claim 1, wherein the threshold ash content is a maximum ash content.

3. The system of claim 1, wherein the sensor is located at an exit of the crop cutting assembly.

4. The system of claim 1, wherein the operating parameter adjusted by the electronic processing element includes a height and an angle of the crop cutting assembly, which the electronic processing element adjusts by sending a control signal to the lift mechanism.

5. The system of claim 1, wherein the operating parameter adjusted by the electronic processing element includes a speed of the crop cutting assembly, which the electronic processing element adjusts by sending a control signal to the crop cutting assembly.

6. The system of claim 1, wherein the operating parameter adjusted by the electronic processing element includes a float pressure of the of the crop cutting assembly, which the electronic processing element adjusts by sending a control signal to the lift mechanism.

7. The system of claim 1, wherein the operating parameter adjusted by the electronic processing element includes a speed of the mower conditioner, which the electronic processing element adjusts by sending a control signal to a speed controller of the mower conditioner.

8. The system of claim 1, wherein the assessment and adjustment process further includes communicating the measured ash content value and the operating parameters adjusted by the electronic processing element to a display for viewing by an operator of the mower conditioner.

9. The system of claim 1, the electronic processing element being further configured to at least periodically perform the assessment and adjustment process during operation of the mower conditioner.

10. The system of claim 1, further including one or more additional sensors including—
a first one or more optical sensors configured to measure a roughness of a cut end of the crop material cut from the field; and
a second one or more optical sensors configured to measure a height of a stubble portion of the crop material left in the field.

11. A mower conditioner configured to control an ash content of a crop material cut by the mower conditioner, the mower conditioner comprising:
a crop cutting assembly configured to cut the crop material from a field;
a lift mechanism configured to raise and lower the crop cutting assembly;
one or more sensors configured to determine a measured ash content value reflecting an amount of ash in the crop material exiting the cutting assembly;
an electronic processing element in communication with the one or more sensors and configured to at least periodically perform an assessment and adjustment process to control the ash content during operation of the mower conditioner, the assessment and adjustment process including—
receiving the measured ash content value,
comparing the measured ash content value to a threshold ash content value, and
if the measured ash content value exceeds the threshold ash content value, automatically adjusting one or more operating parameters of the mower conditioner to optimize the measured ash content value.

12. The mower conditioner of claim 11, wherein the operating parameter adjusted by the electronic processing element includes a height and an angle of the crop cutting assembly, which the electronic processing element adjusts by sending a control signal to the lift mechanism.

13. The mower conditioner of claim 11, wherein the operating parameter adjusted by the electronic processing element includes a speed of the crop cutting assembly, which the electronic processing element adjusts by sending a control signal to the crop cutting assembly.

14. The mower conditioner of claim 11, wherein the operating parameter adjusted by the electronic processing element includes a float pressure of the of the crop cutting assembly, which the electronic processing element adjusts by sending a control signal to the lift mechanism.

15. The mower conditioner of claim 11, wherein the operating parameter adjusted by the electronic processing element includes a speed of the mower conditioner, which the electronic processing element adjusts by sending a control signal to a speed controller of the mower conditioner.

16. The mower conditioner of claim 11, wherein the electronic processing element is further configured to communicate the measured ash content value and the one or more operating parameters adjusted by the electronic processing element to a display for viewing by an operator of the mower conditioner.

17. The mower conditioner of claim 11, further including one or more additional sensors including—
a first one or more optical sensors configured to measure a roughness of a cut end of the crop material cut from the field; and
a second one or more optical sensors configured to measure a height of a stubble portion of the crop material left in the field.

18. The mower conditioner of claim 11, wherein the electronic processing element is further configured to receive an operator-selectable weight value weighting the measured ash content value versus a speed of cutting, and to consider the operator-selectable weight value when adjusting the one or more operating parameters of the mower conditioner to optimize the measured ash content value.

19. The mower conditioner of claim 11, the electronic processing element being further configured to continuously perform the assessment and adjustment process during operation of the mower conditioner.

20. A computer-implemented method for improving the function of a computer for controlling an ash content in a crop material cut by a mower conditioner, the computer-implemented method comprising:
sensing a measured ash content value reflecting an amount of ash in the crop material; and
performing with an electronic processing element an assessment and adjustment process to control the ash content at least periodically during operation of the mower conditioner, the assessment and adjustment process including—
receiving the measured ash content value,
comparing the ash content value to a threshold ash content value,
if the ash content value exceeds the threshold ash content value, automatically adjusting an operating parameter of the mower conditioner to optimize the measured ash content value, and
communicating the measured ash content value and the operating parameter adjusted by the electronic processing element to a display for viewing by an operator of the mower conditioner.
